(19) United States
(12) Patent Application Publication
(10) Pub. No.: US 2024/0151291 A1
(43) Pub. Date: May 9, 2024

(54) MAGNETO RHEOLOGICAL FLUID DEVICE

(71) Applicant: KURIMOTO, LTD., Osaka-shi, Osaka (JP)

(72) Inventors: Hitoshi TSUJI, Osaka-shi (JP); Yuya UESHIMA, Osaka-shi (JP); Tomohiro KOGE, Osaka-shi (JP); Takashi SUEHIRO, Osaka-shi (JP)

(73) Assignee: KURIMOTO, LTD., Osaka-shi, Osaka (JP)

(21) Appl. No.: 18/278,730

(22) PCT Filed: Mar. 24, 2022
(86) PCT No.: PCT/JP2022/014052

§ 371 Date: Aug. 24, 2023

(30) Foreign Application Priority Data
Mar. 24, 2021 (JP) 2021-049822

(51) Int. Cl. F16F 9/53; H01F 1/44

(52) U.S. Cl. CPC F16F 9/535; H01F 1/445; F16D 37/02

(57) ABSTRACT

A magneto rheological fluid device includes a first member 101 and a second member 102 that rotate relative to each other with a layer of a magneto rheological fluid 200 having a predetermined thickness interposed therebetween, and a magnetic field generator 128. The magnetic field generator 128 forms a magnetic path so as to cross the layer of the magneto rheological fluid 200 interposed between the first member 101 and the second member 102 in a thickness direction. The magneto rheological fluid 200 contains fluorine oil as a dispersion medium.

### TECHNICAL FIELD

The present disclosure relates to a magneto rheological fluid device.

### BACKGROUND ART

A magneto rheological (MR) fluid is a fluid in which magnetic particles of iron (Fe) or the like are dispersed in a dispersion medium such as oil. Under no application of a magnetic field to the MR fluid, the magnetic particles are randomly suspended in the dispersion medium. Under application of a magnetic field from the outside to the MR fluid, the magnetic particles form a large number of clusters along a direction of the magnetic field, and the yield stress increases. Thus, the MR fluid is a material that is easy to control rheological characteristics or mechanical properties by using an electric signal. Therefore, application of the MR fluid to various fields is investigated. At present, the MR fluid is mainly used for direct-drive MR fluid devices such as an automotive shock absorber and a seat damper for construction machinery, and application of the MR fluid to rotational MR fluid devices such as a clutch and a brake also proceeds.

A gap between two members that rotate relative to each other in a rotational MR fluid device is filled with the MR fluid. The viscosity of the MR fluid is changed by generating a magnetic field, to control transmission of a torque between the two members (e.g., see Patent Document 1). Such a rotational MR fluid device is required to be compact and to efficiently transmit a torque. Therefore, it is desirable to reduce the amount of MR fluid used as much as possible and to increase the proportion of the MR fluid filled in the gap between two members that transmit a torque and exerts an MR effect in the whole MR fluid, as much as possible.

### CITATION LIST

### Patent Document

Patent Document 1: Japanese Unexamined Patent Publication No. 2014-181778

### SUMMARY OF THE INVENTION

### Technical Problem

However, the inventors of the present application have found that an increase in the proportion of the MR fluid that exerts the MR effect in the whole MR fluid is likely to degrade the MR fluid. For a direct-drive MR fluid device such as a damper, only a MR fluid present at an orifice portion, of the MR fluid filled in the device, contributes to dissipation of kinetic energy. For a rotational MR fluid device that is compact, the MR fluid is filled only in the gap between the two members that rotate relative to each other, and most of the MR fluid contributes to transmission of a torque. Therefore, the total amount of the MR fluid in the rotational MR fluid device is smaller than that in the direct-drive MR fluid device, and the proportion of a MR fluid that does not contribute to transmission of a torque in the rotational MR fluid device is also smaller than that in the direct-drive MR fluid device. This is likely to cause degradation of the MR fluid.

It is an object of the present disclosure is to provide a rotational magneto rheological fluid device that suppresses degradation of a magneto rheological fluid.

### Solution to the Problem

A magneto rheological fluid device of the present disclosure includes: a magneto rheological fluid; and a first member and a second member that rotate relative to each other with a layer of the magneto rheological fluid having a predetermined thickness interposed therebetween; and a magnetic field generator, the magnetic field generator forms a magnetic path so as to cross the layer of the magneto rheological fluid interposed between the first member and the second member in a thickness direction, and the magneto rheological fluid contains fluorine oil as a dispersion medium.

The magneto rheological fluid device of the present disclosure includes a magneto rheological fluid containing fluorine oil as a dispersion medium. Thus, the magneto rheological fluid device is less likely to be degraded even in the rotational magneto rheological fluid device, and the rotational magneto rheological fluid device can stably operate for a long period of time.

### Advantages of the Invention

The magneto rheological fluid device of the present disclosure can suppress degradation of the magneto rheological fluid and stably operate for a long period of time.

### BRIEF DESCRIPTION OF THE DRAWINGS

FIG. 1 is a cross-sectional view of a magneto rheological fluid device according to an embodiment.

### DESCRIPTION OF EMBODIMENTS

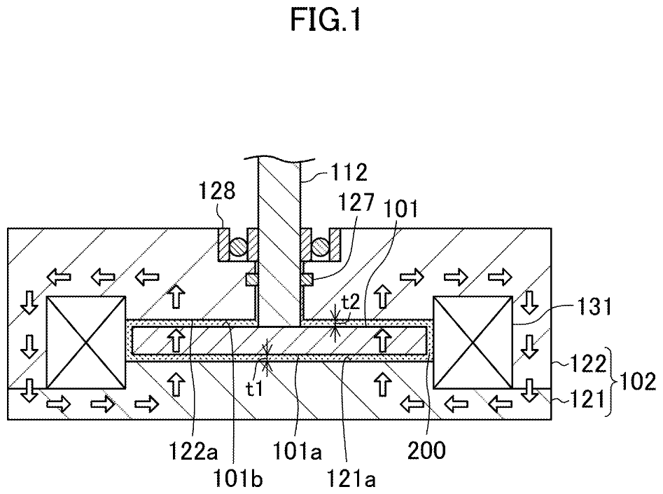

A magneto rheological (MR) fluid device of an embodiment is a rotational MR fluid device, as shown in FIG. 1, and includes a first member and a second member that rotate relative to each other. In the embodiment, the first member is a rotor 101, and the second member is a case 102.

The rotor 101 has a disk shape, and an end of a shaft 112 is connected to the center of the rotor 101. The shaft 112 rotates integrally with the rotor 101. The rotor 101 is preferably a magnetic material, but may be a non-magnetic material.

The case 102 includes a first case 121 and a second case 122, and has a cavity for housing the rotor 101 between the first case 121 and the second case 122. The cavity is filled with a magneto rheological fluid (MR fluid) 200. A layer of the MR fluid having a thickness t1 is interposed between a surface 121a of the cavity on the first case 121 side and a first principal surface 101a of the rotor 101, and a layer of the MR fluid having a thickness t2 is interposed between a surface 122a of the cavity on the second case 122 side and a second principal surface 101b of the rotor 101.

The second case 122 has a shaft hole through which the shaft 112 passes. A gap between the shaft 112 and the shaft hole is sealed with a seal member 127, so as to prevent leakage of the MR fluid 200 with which the cavity is filled. A bearing 128 for rotatably holding the shaft 112 is provided at an end of the shaft hole opposite to the cavity.

A coil 131 for generating a magnetic field is arranged so as to surround the outer edge of the cavity. The case 102 is formed from a magnetic material and functions as a yoke, and a magnetic path is formed so as to cross the layer of the MR fluid 200 with which the cavity is filled, in a thickness direction, as shown in FIG. 1. The magnetic flux density of a magnetic flux along the magnetic path varies depending on the intensity of a current applied to the coil 131. This configuration changes the viscosity of the MR fluid between the surface 121a on the first case 121 side and the first principal surface 101a of the rotor 101 and between the surface 122a on the second case 122 side and the second principal surface 101b of the rotor 101. This viscosity produces a resistive force between the rotor 101 and the case 102. In order to prevent leakage of the MR fluid, a gap between the cavity and the coil 131 is also sealed.

The position of the coil 131 is not limited to the outer edge of the cavity as long as it is a position where the magnetic path is formed appropriately for the fluid. For example, the coil 131 may be positioned so as to face the rotor 101 in the first case 121 or so as to face the rotor 101 in the second case 122. Although the first case 121 and the second case 122 that are each integrally molded are described as an example, the first case 121 and the second case 122 may each include a combination of a plurality of members.

In the MR fluid device of the embodiment, the resistive force generated between the rotor 101 and the case 102 varies depending on the distance t1 between the surface 121a on the first case 121 side and the first principal surface 101a of the rotor 101 and the distance t2 between the surface 122a on the second case 122 side and the second principal surface 101b of the rotor 101. The distance t1 may be the same as or different from the distance t2.

In the MR fluid device of the embodiment, a part of the magnetic path extends in a direction along a rotation axis of the rotor 101, and is orthogonal to the layer of the MR fluid interposed between the rotor 101 and the case 102. Therefore, the viscosity of the whole layer of the MR fluid with which the gap between the rotor 101 and the case 102 is filled varies depending on the magnetic flux density of the magnetic flux along the magnetic path, and a torque can be further efficiently transmitted.

In the MR fluid device, an effective volume ratio that is the ratio of an effective work volume contributing to torque transmission to the total volume of the MR fluid is represented by the following equation (1).

Effective volume ratio=effective work volume/total volume (1)

In the equation (1), the total volume is the volume of the whole MR fluid with which the device is filled. For a direct-drive MR fluid device such as a damper, the total volume is generally the volume of a space that is filled with the MR fluid in a cylinder. For a rotational MR fluid device such as a clutch or a brake, the total volume is generally the volume of a space that is filled with the MR fluid in a case housing a rotor. The effective work volume is the volume of the MR fluid that contributes to torque transmission. For a direct-drive MR fluid device such as a damper, the effective work volume is generally the volume of the MR fluid present at an orifice portion to which a magnetic field is applied. For a rotational MR fluid device such as a clutch or a brake, the effective work volume is generally the volume of the MR fluid present in a space where the rotor and the case face each other.

In the direct-drive MR fluid device, the effective volume ratio is generally 0.2 or less. For the rotational MR fluid device, the cavity for housing the rotor has a large dead volume, and a portion where the magnetic path is not formed is also filled with the MR fluid, and therefore the effective volume ratio has been small. However, when the cavity is made smaller to reduce the dead volume as much as possible in order to reduce the size of the MR fluid device, the effective volume ratio is increased. In particular, when the magnetic path is formed so as to be orthogonal to the layer of the MR fluid interposed between the rotor and the case such as in the embodiment, the whole layer of the MR fluid interposed between the rotor and the case contributes to torque transmission. Therefore, the dead volume is closer to approximately 0. Accordingly, a device in which the effective volume ratio is 0.3 or more, further 0.7 or more, and approximately 1.0 also exists.

The inventors of the present application have examined a degradation rate that depends on the kind of dispersion medium in a MR fluid with which a rotational MR fluid device having an effective volume ratio of 0.3 or more is filled, and found that when the dispersion medium is fluorine oil, an increase or decrease in the viscosity of the MR fluid during long-term use in the device having a high effective volume ratio is suppressed.

For example, when a degradation time is a time until a torque is increased by 50%, the degradation time of the MR fluid in which the dispersion medium is fluorine oil is approximately 3 to 6 times that of the MR fluid in which the dispersion medium is poly-α-olefin oil, approximately 10 to 20 times that of the MR fluid in which the dispersion medium is polyolester oil, and approximately 15 to 30 times that of the MR fluid in which the dispersion medium is silicone oil at a shear stress of approximately 3500 Pa, and is approximately 6 to 15 times that of the MR fluid in which the dispersion medium is poly-α-olefin oil, approximately 80 to 200 times that of the MR fluid in which the dispersion medium is polyolester oil, and approximately 400 to 1000 times that of the MR fluid in which the dispersion medium is silicone oil at a shear stress of approximately 35000 Pa.

The durability of the MR fluid can be evaluated as the magnitude of dissipation energy that is energy consumed until the degradation time. By comparison of the dissipation energy until the degradation time, influences caused by a difference in the viscosity of the dispersion medium and a difference in a torque change until degradation are eliminated, and the durability of the MR fluid can be evaluated. The dissipation energy until the degradation time can be determined by the following equation (2).

Dissipation energy [J]=2π/60×torque [Nm]×the number of revolutions [rpm]×degradation time [s] (2)

For example, when the degradation time is a time until a torque is increased by 50%, the dissipation energy until the degradation time of the MR fluid in which the dispersion medium is fluorine oil is approximately 3 to 5 times that of the MR fluid in which the dispersion medium is poly-α-olefin oil, approximately 9 to 12 times that of the MR fluid in which the dispersion medium is polyolester oil, and approximately 10 to 15 times that of the MR fluid in which the dispersion medium is silicone oil at a shear stress of approximately 3500 Pa, and is approximately 4 to 10 times that of the MR fluid in which the dispersion medium is poly-α-olefin oil, approximately 50 to 120 times that of the MR fluid in which the dispersion medium is polyolester oil, and approximately 200 to 500 times that of the MR fluid in which the dispersion medium is silicone oil at a shear stress of approximately 35000 Pa.

The MR fluid in which the dispersion medium is fluorine oil is less likely to be degraded even during use at a high shear stress than a MR fluid in which the dispersion medium is hydrocarbon oil or the like. For example, when the degradation time is a time until a torque is increased by 50%, the degradation time of the MR fluid in which the dispersion medium is fluorine oil is approximately 3 to 20 times that of the MR fluid in which the dispersion medium is synthetic oil or silicone oil at a shear stress of approximately 3500 Pa. The degradation time of the MR fluid in which the dispersion medium is fluorine oil at a shear stress of approximately 35000 Pa is 50% or more, and preferably 60% or more, of the degradation time at the shear stress of approximately 3500 Pa, whereas the degradation time of the MR fluid in which the dispersion medium is another dispersion medium such as poly-α-olefin oil is 30% or less at best, or 10% or less at worst, of the same.

In the evaluation of dissipation energy, the dissipation energy until the degradation time of the MR fluid in which the dispersion medium is fluorine oil at a shear stress of approximately 35000 Pa is higher than that at a shear stress of approximately 3500 Pa, preferably 1.8 times or more, more preferably 3.0 times or more that at a shear stress of approximately 3500 Pa. The dissipation energy is approximately 1.6 times in the use of poly-α-olefin oil, approximately 0.3 times in the use of polyolester oil, and approximately 0.1 times in the use of silicone oil. As the shear stress increases, degradation abruptly occurs.

Therefore, the MR fluid in which the dispersion medium is fluorine oil exerts an excellent effect during use at a shear stress of preferably 3000 Pa or more, more preferably 5000 Pa or more, yet more preferably 10000 Pa or more, still more preferably 30000 Pa or more.

In the MR fluid of this embodiment, the dispersion medium in which magnetic particles are dispersed is fluorine oil. The fluorine oil is oil in which at least some of hydrogen atoms of a hydrocarbon chain is substituted by fluorine atoms. Perfluoropolyether, polyfluoroalkyl, polychloro trifluoroethylene, or the like can be used. Perfluoropolyether is a polymer containing a unit represented by a general formula: —CₓF₂ₓO— (wherein X is an integer of 1 to 4) as a main repeating unit. Polyfluoroalkyl is a polymer represented by a formula: R1-(CF₂)ₙ—R2 (wherein n is an integer). R1 and R2 can be those represented by the following chemical formula 1. R1 and R2 may be the same as or different from each other.

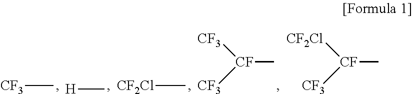

Among them, perfluoropolyether (PFPE) oil and polychloro trifluoroethylene (CTFE) oil are preferred, and PFPE oil containing C₂F₄O and CF₂O as a repeating unit is particularly preferred.

The magnetic particles in the MR fluid of the embodiment are not particularly limited, and iron, iron nitride, iron carbide, carbonyl iron, chromium dioxide, low-carbon steel, nickel, cobalt, or the like can be used. An iron alloy such as an aluminum-containing iron alloy, a silicon-containing iron alloy, a cobalt-containing iron alloy, a nickel-containing iron alloy, a vanadium-containing iron alloy, a molybdenum-containing iron alloy, a chromium-containing iron alloy, a tungsten-containing iron alloy, a manganese-containing iron alloy, or a copper-containing iron alloy can also be used. Paramagnetic, superparamagnetic, or ferromagnetic compound particles of gadolinium, an organic derivative of gadolinium, particles of a mixture thereof, or the like can also be used. Among them, carbonyl iron is preferred because particles having an average particle diameter suitable for the magnetic particles are easily obtained.

The average primary particle diameter of the magnetic particles is not particularly limited. From the viewpoint of functioning as the MR fluid and suppressing precipitation, it is preferably 0.01 μm or more, more preferably 0.1 μm or more, yet more preferably 1 μm or more, still more preferably 5 μm or more, and preferably 100 μm or less, more preferably 50 μm or less, yet more preferably 30 μm or less, still further preferably 20 μm or less. The magnetic particles are not particularly limited. From the viewpoint of suppressing precipitation, the density is preferably 5 g/cm³ or more, more preferably 6 g/cm³ or more, and preferably 9 g/cm³ or less, more preferably 8 g/cm³ or less.

In order to improve affinity to the fluorine oil, the magnetic particles may be treated such that hydrophobic properties are made higher than the surface of the particles themselves, if necessary. For example, a hydroxyl group may be introduced into the surface of the magnetic particles themselves and bonded to a hydrophobic compound having a functional group which reacts with the hydroxyl group. Alternatively, the hydroxyl group introduced into the surface of the magnetic particles can be bonded to the compound using a bifunctional coupling agent.

From the viewpoint of exerting a magneto rheological effect, the ratio of the magnetic particles to the whole MR fluid is preferably 55 mass % or more, more preferably 65 mass % or more. From the viewpoint of reducing the base viscosity, it is preferably 85 mass % or less, more preferably 80 mass % or less.

To the MR fluid of the embodiment, various additives can be added. From the viewpoint of achieving long-term stability, a publicly known additive that is generally used as a lubricant, for example, an anti-settling agent, a metal-based detergent dispersant, an ashless detergent dispersant, an oily agent, an anti-wear agent, an extreme pressure agent, an anti-corrosive agent, a friction modifier, a solid lubricant, an antioxidant, a metal deactivator, an anti-foaming agent, a colorant, a viscosity index improver, a pour-point depressant, or the like can also be added. In order to ensuring various performances of a magneto rheological fluid composition, a publicly known additive that is generally used as a lubricant, for example, a metal detergent dispersant, an ashless detergent dispersant, an oily agent, an anti-wear agent, an extreme pressure agent, an anti-corrosive agent, a friction modifier, a solid lubricant, an antioxidant, a metal deactivator, an anti-foaming agent, a colorant, a viscosity index improver, a pour-point depressant, or the like can be added.

An affinity improver for improving affinity of the magnetic particles to the fluorine oil can be added. As the affinity improver, for example, a polymer dispersant or a surfactant that is generally used as a lubricant can be used. The amount of the affinity improver added is not particularly limited, and desirably falls within the range of 1 mass % to 45 mass % with respect to the mass of a solvent.

The MR fluid device of the embodiment is compact, can transmit a torque, and generate a resistive force, and is less likely to degrade the MR fluid. Therefore, the MR fluid device can be stably used for a long period of time. The MR fluid device is applicable to an input device, a brake, a clutch, and the like.

### EXAMPLES

Hereinafter, the MR fluid device of the present disclosure will be described in detail using Examples. Examples are illustrative and are not intended to limit the present disclosure.

<MR Effect Confirmation Test>

The shear stress was determined under application of a magnetic field at a magnetic flux density of 100 mT and 500 mT using a parallel plate rotational viscometer having a plate diameter of 20 mm and a plate interval of 0.5 mm. The shear rate was 100 s⁻¹, and the measurement time was 60 seconds.

<Durability Evaluation Test 1>

The torque was measured using a parallel plate rotational viscometer having a plate diameter of 20 mm and a plate interval of 1 mm. In the measurement, a magnetic field was applied at the number of revolutions of 800 rpm and a magnetic flux density of 500 mT. A degradation time was a time until the torque was increased or decreased by 20% from an initial state. In the test device, the effective volume ratio of a MR fluid was 1.0.

The dissipation energy (Ed) until degradation occurred was calculated by applying the value of torque obtained and the degradation time to the following equation (2).

Dissipation energy [J]=2π/60×torque [Nm]×the number of revolutions [rpm]×degradation time [s] (2)

<Durability Evaluation Test 2>

The torque was measured using a parallel plate rotational viscometer having a plate diameter of 46 mm and a plate interval of 1 mm. In the measurement, a magnetic field was applied at the number of revolutions of 300 rpm and a magnetic flux density of 100 mT and 500 mT. A degradation time was a time until the torque was increased or decreased by 50% from an initial state. In the test device, the effective volume ratio of a MR fluid was 1.0.

The dissipation energy (Ed) until degradation occurred was calculated by applying the value of torque obtained and the degradation time to the equation (2). The ratio of the dissipation energy at a magnetic flux density of 500 mT to the dissipation energy at a magnetic flux density of 100 mT was calculated.

### Example 1

A MR fluid was prepared from perfluoropolyether (PFPE) oil (kinematic viscosity at 20° C.: 66 mm²/s, specific gravity: 1.8) as a dispersion medium and a carbonyl iron powder having an average primary particle diameter of 6 μm as magnetic particles. The magnetic particles and the dispersion medium were mixed in a container with hands using a spatula, and then subjected to high shear mixing with a planetary centrifugal mixer (MAZERUSTAR manufactured by Kurabo Industries Ltd.), to disperse the magnetic particles in the dispersion medium. The ratio of the mass of the magnetic particles to the total mass of the MR fluid was set to approximately 83 mass %.

The shear stress at a magnetic flux density of 100 mT was 3.6 kPa, and the shear stress at a magnetic flux density of 500 mT was 39.1 kPa, which exhibited a sufficient MR effect.

In the durability evaluation test 1, the time until the torque was increased by 20% was 132.25 hours, and the dissipation energy was 4.4×10⁶ J.

In the durability evaluation test 2, the time until the torque at a magnetic flux density of 100 mT was increased by 50% was 603 hours, and the dissipation energy was 9.7×10⁶ J. The time until the torque at a magnetic flux density of 500 mT was increased by 50% was 426 hours, and the dissipation energy was 32.0×10⁶ J.

The same measurement as in the durability evaluation test 2 was carried out using a MR fluid device that was provided with an oil pool to achieve an effective volume ratio of 0.29. The time until the torque at a magnetic flux density of 500 mT was increased by 50% was 424 hours, and the dissipation energy was 34.1×10⁶ J. The dissipation energy of the device in which the effective volume ratio at a magnetic flux density of 500 mT was 1.0 was approximately 94% of that of the device in which the effective volume ratio was 0.29. In the device in which the effective volume ratio was high, degradation was less likely to occur.

### Example 2

Preparation was carried out in the same manner as in Example 1 except that the dispersion medium was changed to polychloro trifluoroethylene (CTFE) oil (kinematic viscosity at 25° C.: 35 mm²/s, specific gravity: 1.9).

The shear stress at a magnetic flux density of 100 mT was 3.8 kPa, and the shear stress at a magnetic flux density of 500 mT was 35.2 kPa, which exhibited a sufficient MR effect.

In the durability evaluation test 1, the time until the torque was increased by 20% was 48.58 hours, and the dissipation energy was 1.4×10⁶ J.

In the durability evaluation test 2, the time until the torque at a magnetic flux density of 100 mT was increased by 50% was 300 hours, and the dissipation energy was 7.6×10⁶ J. The time until the torque at a magnetic flux density of 500 mT was increased by 50% was 163 hours, and the dissipation energy was 14.1×10⁶ J.

### Comparative Example 1

Preparation was carried out in the same manner as in Example 1 except that the dispersion medium was changed to poly-α-olefin (PAO) oil (kinematic viscosity at 100° C.: 10 mm²/s).

The shear stress at a magnetic flux density of 100 mT was 3.9 kPa, and the shear stress at a magnetic flux density of 500 mT was 35.4 kPa, which exhibited a sufficient MR effect.

In the durability evaluation test 1, the time until the torque was increased by 20% was 1.75 hours, and the dissipation energy was 8.1×10⁴ J.

In the durability evaluation test 2, the time until the torque at a magnetic flux density of 100 mT was increased by 50% was 90.8 hours, and the dissipation energy was 2.0×10⁶ J. The time until the torque at a magnetic flux density of 500 mT was increased by 50% was 25.6 hours, and the dissipation energy was 3.2×10⁶ J.

The same measurement as in the durability evaluation test 2 was carried out using a MR fluid device that was provided with an oil pool to achieve an effective volume ratio of 0.29. The time until the torque at a magnetic flux density of 500 mT was increased by 50% was 189 hours, and the dissipation energy was 14.4×10⁶ J. The dissipation energy of the device in which the effective volume ratio at a magnetic flux density of 500 mT was 1.0 was approximately 22% of that of the device in which the effective volume ratio was 0.29. In the device in which the effective volume ratio was high, degradation was likely to occur.

### Comparative Example 2

Preparation was carried out in the same manner as in Example 1 except that the dispersion medium was changed to polyolester (POE) oil (kinematic viscosity at 100° C.: 4.4 mm²/s).

The shear stress at a magnetic flux density of 100 mT was 3.4 kPa, and the shear stress at a magnetic flux density of 500 mT was 33.9 kPa, which exhibited a sufficient MR effect.

In the durability evaluation test 1, the time until the torque was increased by 20% was 0.42 hours, and the dissipation energy was 2.0×10⁴ J.

In the durability evaluation test 2, the time until the torque at a magnetic flux density of 100 mT was increased by 50% was 28.1 hours, and the dissipation energy was 0.84×10⁶ J. The time until the torque at a magnetic flux density of 500 mT was increased by 50% was 2.0 hours, and the dissipation energy was 0.26×10⁶ J.

### Comparative Example 3

Preparation was carried out in the same manner as in Example 1 except that the dispersion medium was changed to silicone oil (kinematic viscosity at 25° C.: 50 mm²/s).

The shear stress at a magnetic flux density of 100 mT was 3.4 kPa, and the shear stress at a magnetic flux density of 500 mT was 34.4 kPa, which exhibited a sufficient MR effect.

In the durability evaluation test 1, the time until the torque was increased by 20% was 1.00 hours, and the dissipation energy was 4.3×10⁴ J.

In the durability evaluation test 2, the time until the torque at a magnetic flux density of 100 mT was increased by 50% was 17.5 hours, and the dissipation energy was 0.55×10⁶ J. The time until the torque at a magnetic flux density of 500 mT was increased by 50% was 0.38 hours, and the dissipation energy was 0.06×10⁶ J.

Examples and Comparative Examples are summarized in Tables 1 and 2.

TABLE 1

| | Example | Example | Comparative | Comparative | Comparative |
|---|---|---|---|---|---|
| | 1 | 2 | Example 1 | Example 2 | Example 3 |
| Dispersion | PFPE | CTFE | PAO | POE | Silicone |
| medium | | | | | |
| Dissipation | 4.4 × 10⁶ | 1.4 × 10⁶ | 8.1 × 10⁴ | 2.0 × 10⁴ | 4.3 × 10⁴ |
| energy [J] | | | | | |

TABLE 2

| | | | | Comparative | Comparative | Comparative |
|---|---|---|---|---|---|---|
| | | Example 1 | Example 2 | Example 1 | Example 2 | Example 3 |
| Dispersion medium | | PFPE | CTFE | PAO | POE | Silicone |
| 100 mT | Shear stress [kPa] | 3.6 | 3.8 | 3.9 | 3.4 | 3.4 |
| (Effective | Degradation time | 603 | 300 | 90.8 | 28.1 | 17.5 |
| volume | [hour] | | | | | |
| ratio: 1.0) | Dissipation | 9.7 × 10⁶ | 7.6 × 10⁶ | 2.0 × 10⁶ | 0.84 × 10⁶ | 0.55 × 10⁶ |
| | energy [J] | | | | | |
| 500 mT | Shear stress [kPa] | 39.1 | 35.2 | 35.4 | 33.9 | 34.4 |
| (Effective | Degradation time | 426 | 163 | 25.6 | 2.0 | 0.38 |
| volume | [hour] | | | | | |
| ratio: 1.0) | Dissipation | 32.0 × 10⁶ | 14.1 × 10⁶ | 3.2 × 10⁶ | 0.26 × 10⁶ | 0.06 × 10⁶ |
| | energy [J] | | | | | |
| 500 mT | Degradation time | 424 | — | 189 | — | — |
| (Effective | [hour] | | | | | |
| volume | Dissipation | 34.1 × 10⁶ | — | 14.4 × 10⁶ | — | — |
| ratio: 0.29) | energy [J] | | | | | |
| | (1.0)/(0.29) | 94% | — | 22% | — | — |

### INDUSTRIAL APPLICABILITY

The magneto rheological fluid device of the present disclosure can suppress degradation of the magneto rheological fluid and stably operate for a long period of time, and is useful as a rotational torque transmitter including a brake, a clutch, and the like.

### DESCRIPTION OF REFERENCE CHARACTERS

101 Rotor
101a First Main Surface
101b Second Main Surface
102 Case
112 Shaft
121 First Case
121a Surface on First Case Side
122 Second Case
122a Surface on Second Case Side
127 Seal Member
128 Bearing
131 Coil
200 MR Fluid

1. A magneto rheological fluid device comprising:
a magneto rheological fluid including magnetic particles and a dispersion medium; and
a first member and a second member that rotate relative to each other with a layer of the magneto rheological fluid having a predetermined thickness interposed therebetween; and
a magnetic field generator,
the magnetic field generator forming a magnetic path so as to cross the layer of the magneto rheological fluid interposed between the first member and the second member, in a thickness direction,
the magneto rheological fluid containing fluorine oil as the dispersion medium.

2. The magneto rheological fluid device of claim 1, wherein the dispersion medium is perfluoropolyether or chlorotrifluoroethylene.

3. The magneto rheological fluid device of claim 1, wherein a shear stress of the magneto rheological fluid under application of a magnetic field is 3000 Pa or more.

4. The magneto rheological fluid device of claim 1, wherein
an effective volume ratio represented by the following equation (1) is from 0.3 to 1.0 inclusive,
Effective volume ratio=effective work volume/total volume (1),
wherein in the equation (1), a total volume is a total volume of the magneto rheological fluid in the device, and an effective work volume is a volume of the magneto rheological fluid that contributes to torque transmission, of the magneto rheological fluid in the device.

5. The magneto rheological fluid device of claim 1 wherein the magnetic particles are carbonyl iron particles.

6. The magneto rheological fluid device of claim 5 wherein the carbonyl iron particles are non-surface treated particles.

7. The magneto rheological fluid device of claim 1 wherein
a dissipation energy represented by the following equation (2) at a shear stress of 35000 Pa is 1.8 times or more that at a shear stress of 3500 Pa,
Dissipation energy [J]=2π/60×torque [Nm]×the number of revolutions [rpm]×degradation time [s] (2)
wherein the equation (2), the degradation time is a time until a torque is increased by 50%.

8. The magneto rheological fluid device of claim 4 wherein
the first member is a rotor,
the second member is a case for housing the rotor, and
the cavity is filled by the magneto rheological fluid.

9. The magneto rheological fluid device of claim 8 wherein the case made from a magnetic material.

10. The magneto rheological fluid device of claim 8 wherein the magnetic field generator is arranged outside of the cavity.

11. The magneto rheological fluid device of claim 8 wherein
the layer of the magneto rheological fluid has a first layer formed between a first surface of the rotor and the case and a second layer formed between a second surface of the rotor and the case, and
the magnetic field generator forms the magnetic path so as to cross the first layer and the second layer, in a thickness direction.
